(19) United States
(12) Patent Application Publication
(10) Pub. No.: US 2022/0132869 A1
(43) Pub. Date: May 5, 2022

(54) TORTILLA-MAKING PROCESS

(71) Applicant: Wenger Manufacturing Inc., Sabetha, KS (US)

(72) Inventors: Brian S. Plattner, Sabetha, KS (US); Christopher Dohl, Netawaka, KS (US)

(73) Assignee: Wenger Manufacturing Inc., Sabetha, KS (US)

(21) Appl. No.: 17/516,472

(22) Filed: Nov. 1, 2021

Related U.S. Application Data
(60) Provisional application No. 63/109,047, filed on Nov. 3, 2020.

(51) Int. Cl. A21D 13/42; A21C 11/00; A23L 5/10; A21D 13/066; A21C 3/04; A21D 13/047

(52) U.S. Cl. CPC A21D 13/42; A21C 11/006; A23L 5/11; A23V 2002/00; A21C 3/04; A21D 13/047; A21D 13/066

(57) ABSTRACT

Methods for the production of a variety of tortilla products involve initial extrusion of one or more grain(s) and/or legume(s) using a twin-screw extruder, followed by mixing the extrudate with water and other ingredients to form a tortilla dough. The dough is then subdivided and formed into a flat tortilla shape, followed by cooking. The grain(s) and/or legume(s) may be previously extruded as a part of a continuous process. High quality tortilla products may be produced using a wide variety of grain(s) and/or legume(s), including gluten-free ingredients.

### CROSS-REFERENCE TO RELATED APPLICATION

This application claims the benefit of provisional application Ser. 63/109,047, filed Nov. 3, 2020, which is incorporated by reference herein in its entirety.

### BACKGROUND OF THE INVENTION

### Field of the Invention

The present invention is broadly concerned with a tortilla-making process which uses one or more extruded grain(s) and/or legume(s) the principal ingredient of the tortillas. More particularly, it is concerned with such processes wherein initially extruded grain(s) and/or legume(s) are ground and mixed with water and other ingredients of a tortilla recipe to form a dough. The dough is then divided into portions which are flattened, followed by baking and optional frying. The invention permits the use of a wide variety of grains and/or legumes which have previously not been usable in tortilla making, including gluten-free products.

### Description of the Prior Art

Corn tortillas are a staple of many diets, and have been produced for thousands of years. In the traditional process of making corn tortillas, whole kernel corn is cooked in a mixture of water and lime to a temperature of around 157-200° F. The corn is then allowed to steep in lime water to penetrate and at least dissolve the pericarp or bran fraction of the corn. The corn is then washed and the debranned corn is passed through a grinder to mill the corn to a desired particle size to thus complete the flour preparation. This process, and variants thereof, is known in the art as nixtamalization. The ground corn is then mixed with water and other ingredients to form a dough. The dough is thin-sheeted and corn tortilla precursors are cut from the sheeted dough. These precursors are then baked to provide final tortilla products. The baked corn tortilla products may be cut and deep fried to produce chips.

There are some reports of using a single-screw extruder for the initial processing of corn in corn tortilla manufacture. However, these efforts have been generally confined to laboratory-scale experiments, as opposed to commercial production. See, e.g., Arámbula, et al., “Effects of Starch Gelatinisation on the Thermal, Dielectric and Rehealogical Properties of Extruded Corn Masa,” Journal of Cereal Science 27 (1998) 147-155; Arámbula et al., “Milling and Processing Parameters for Corn Tortillas from Extruded Instant Dry Masa Flour,” Journal of Food Science 63:2 (1998) 338-341; Arámbula et al., “Corn Masa and Tortillas from Extruded Instant Corn Flour Containing Hydrocolloids and Lime,” Journal of Food Science 64:1 (1999) 120-124; Arámbula-Villa et al., “Physicochemical, Structural and Textural Properties of Tortillas from Extruded Instant Corn Flour Supplemented with Various Types of Corn Lipids,” Journal of Cereal Science 33 (2001) 245-252; Arámbula et al., “Characteristics of Tortillas Prepared from Dry Extruded Masa Flour Added with Maize Pericarp,” Journal of Food Science 67:4 (2002) 1444-1448; and “Bazúa et al., “Extruded Corn Flour as an Alternative to Lime-Heated Corn Flour for Tortilla Preparation,” Journal of Food Science 44:3 (1979).

Flour tortillas, usually made using wheat, are also staple products. In the manufacture of flour tortillas, refined or whole-wheat flour is mixed with water, fat, and salt, and often with a leavening agent, such as baking powder, in order to form a dough. This dough is then divided into small portions of rounded ball-like shape, that are subsequently proofed and then hot pressed to form a flattened precursor. These precursor products are then baked in a multiple-tier oven to further denature the wheat gluten and gelatinize the starch content of the wheat. Alternately, the wheat dough may be flattened and die cut before baking to produce tortillas for burritos and fried products. In certain procedures, the flattened precursor products are griddled, rather than baked. However produced, flour tortillas are typically flour-dusted as a final preparative step.

Attempts have been made in the past to produce flour-type tortillas using grains other than wheat, or with wheat and other grains in combination. However, these efforts have generally produced sub-standard products that require the addition of special ingredients such as gums and pregelled starches, or are very expensive. There is accordingly a need in the art for improved methods for producing a variety of tortilla products, and particularly those made from non-corn grains and/or legumes, which avoid the problems of the prior art.

Other references include U.S. Pat. Nos. 5,532,013, 7,749,552, 9,288,998, 10,080,369; US Patent Publication No. 2003/0232103; PCT Publication No. WO 2007/100237.

### SUMMARY OF THE INVENTION

The present invention provides new and improved methods for the production of a wide variety of tortilla products, generally comprising the steps of forming a flat tortilla product precursor using a tortilla product recipe with one or more previously extruded and ground grain(s) and/or legume(s) and water. This forming step includes the step of pressing a quantity of the precursor between a pair of heated forming plates, where the extruded and ground grain(s) and/or legume(s) were previously produced by passing grain(s) and/or legume(s) into and through a twin-screw extruder to yield extrudate(s) having a cold water viscosity of up to about 600 cP, and thereafter grinding the extrudate(s) to a suitable particle size. The precursors are then cooked, typically by baking or griddling, to provide finished tortilla product. A wide variety of grains and/or legumes may be used in the methods of the invention.

The extruded grains and/or legumes may be previously processed, or may be processed in-line in a continuous manner. In the latter cases, the methods of the invention involve first extruding one or more grain(s) and/or legume(s) through a twin-screw extruder to yield an extrudate having a cold water viscosity of up to about 600 cP, followed by grinding of the extrudate. The ground extrudate is mixed with additional ingredients and water to give a tortilla product recipe dough. Flat tortilla product precursors are then formed from the dough, and the latter are heated to produce the final product.

The overall extrusion process of the invention also preferably includes an initial preconditioning step where the grain(s) and/or legume(s) are partially precooked and moisturized. In this condition, the materials are fed to the twin-screw extruder.

An important aspect of the invention is the ability to produce high-quality tortilla products using a variety of different grain(s) and/or legume(s), at relatively low cost as compared with prior processes.

### BRIEF DESCRIPTION OF THE DRAWINGS

FIG. 1 is a side elevational view of a cooking extruder in accordance with the invention, equipped with obliquely oriented steam injection ports and injectors;

FIG. 2 is a front end view of the cooking extruder depicted in FIG. 1;

FIG. 3 is a vertical sectional view taken along line 3-3 of FIG. 2;

FIG. 4 is a vertical sectional view taken along line 4-4 of FIG. 1;

FIG. 5 is a schematic illustration of an orthogonal resolution of the longitudinal axis of one of the extruder barrel injection ports, illustrating the resolution components;

FIG. 6 is a plan view of a pair of intermeshed extruder screws for use in the preferred twin screw extruder of the invention;

FIG. 7 is an enlarged, fragmentary view of portions of the screws of FIG. 6, illustrating the pitches and clearances between sections of the screws;

FIG. 8 is a somewhat schematic plan view of a preferred preconditioner for use with the extruder of the invention;

FIG. 9 is a front elevational view of the preconditioner of FIG. 6;

FIG. 10 is a vertical sectional view of a twin screw extruder of a different configuration as compared with the extruder of FIGS. 1-4, having steam injection ports and injectors located along the intermeshed region of the extruder screws and oriented perpendicularly relative to the longitudinal axes of the extruder screws;

FIG. 11 is a vertical sectional view taken along the line of 11-11 of FIG. 10;

FIG. 12 is a set of RVA viscosity curves for the extruded, ground, white, yellow, and blue corn products described in Example 1; and

FIG. 13 is a schematic representation of the equipment and process for making tortilla products in accordance with the invention;

FIG. 14 is a set of RVA viscosity curves for certain of the extruded and ground products of Example 2.

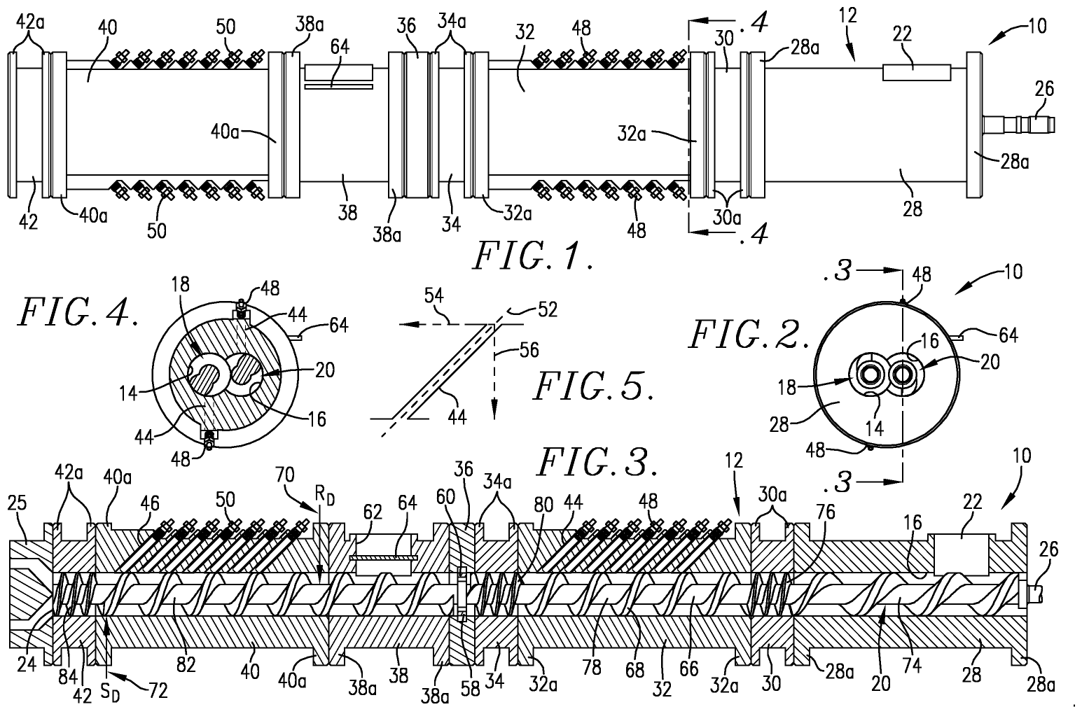

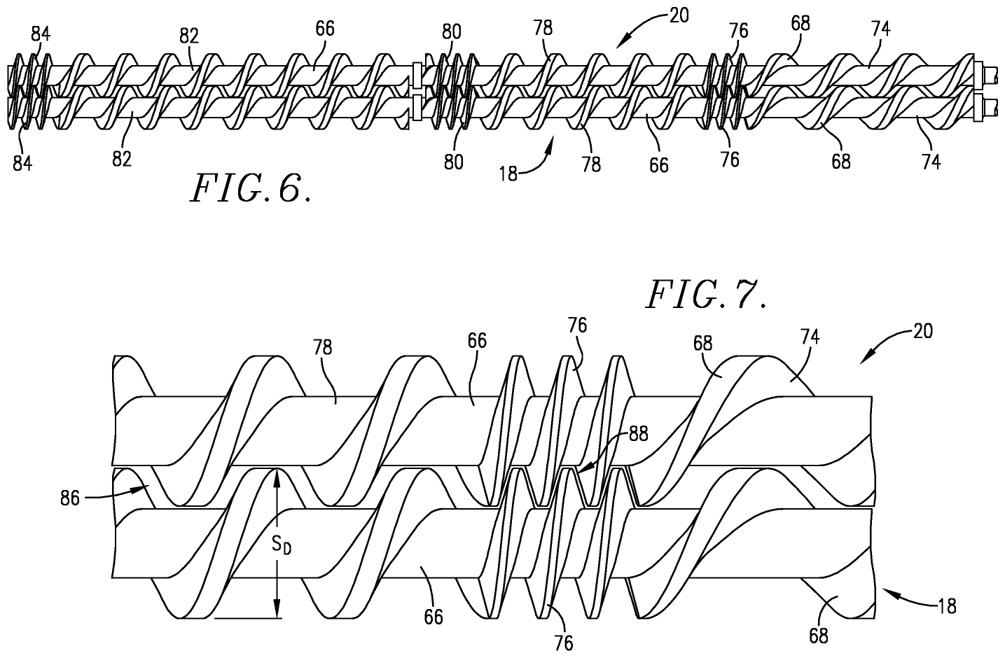

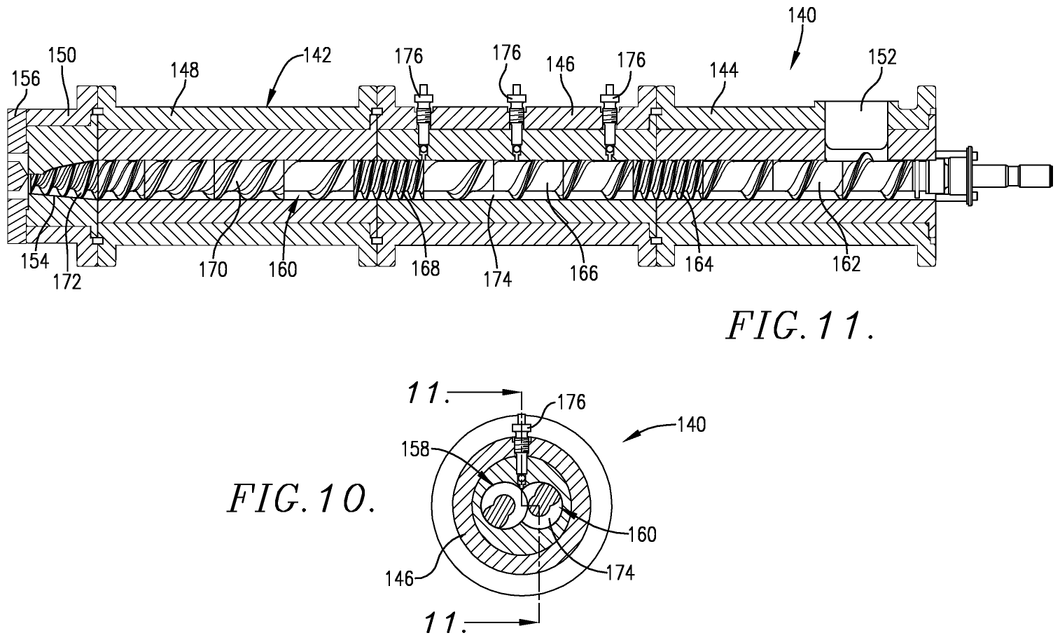

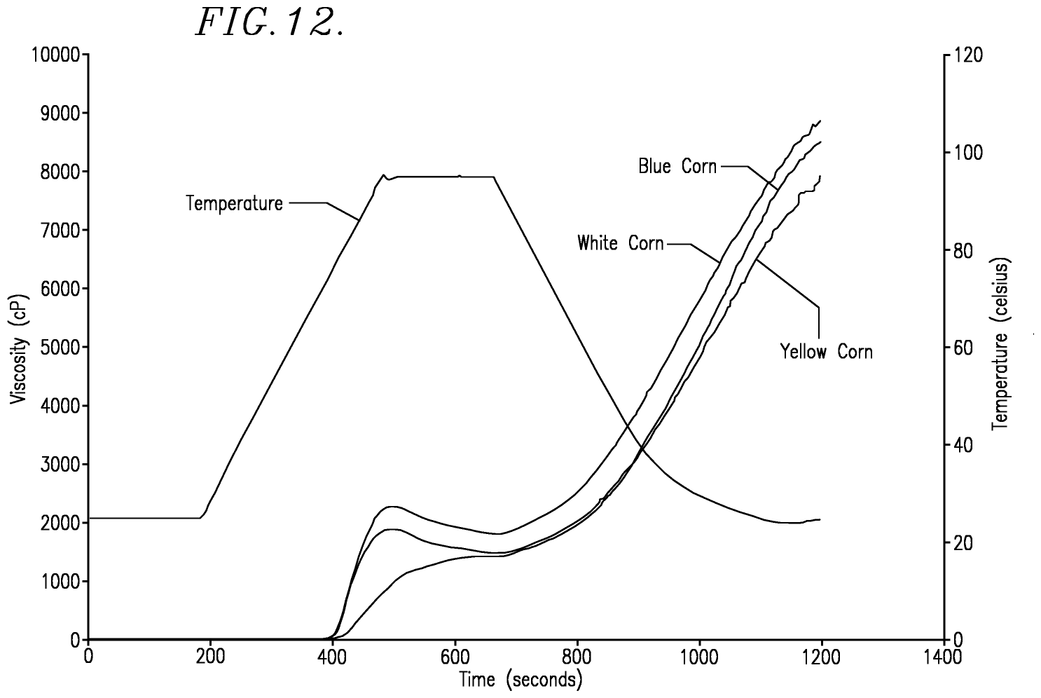

While the drawings do not necessarily provide exact dimensions or tolerances for the illustrated components or structures, FIGS. 1-11 are to scale with respect to the relationships between the components of the structures illustrated therein.

### DETAILED DESCRIPTION OF THE PREFERRED EMBODIMENTS

As noted, the present invention involves pretreatment of selected grain(s) and/or legume(s) prior to use thereof in the fabrication of tortillas. This pretreatment comprises twin-screw extrusion, and normally preconditioning prior to such extrusion. The extruded products are then dried to a shelf stable moisture, and ground for use in tortilla making.

The following sets forth preferred equipment and methods for carrying out the present invention, although other twin-screw devices and preconditioners may be employed.

### Preferred Extruder

Turning now to the drawing, a cooking extruder 10 in accordance with the invention includes an elongated, tubular, multiple-section barrel 12 presenting juxtaposed, intercommunicated chambers or bores 14, 16, and a pair of elongated, helically flighted, axially rotatable, juxtaposed, intercalated screws 18 and 20 within the bores 14, 16. The barrel 12 includes an inlet 22 and a spaced outlet 24 which communicate with the bores 14, 16. A restricted orifice die 25 is positioned across outlet 24 for extrusion purposes and to assist in maintaining pressure within the barrel 12. Additionally, the drive ends 26 of the screws 18, 20 are operably coupled with a drive assembly (not shown) for axially rotation of the screws 18, 20, which typically includes a drive motor and gear reduction assembly.

In more detail, the barrel 12 includes, from right to left in FIGS. 1 and 3, a series of tubular sections connected end-to-end by conventional bolts or other fasteners. Specifically, the barrel 12 has an inlet head 28, a first short steam restriction head 30, a first steam injection head 32, a second short steam restriction head 34, a mid-barrel adjustable valve assembly head 36, an adjustable steam outlet head 38, a second steam injection head 40, and third short steam restriction head 42. As illustrated, each of the heads 28-34 and 38-42 is equipped with endmost, radially enlarged connection flanges 28a-34a and 38a-42a, and all of the heads 28-42 have aligned through-bores which cooperatively form the barrel bores 14 and 16. The head 36 likewise has through bores mating with those of flanges 32a and 38a.

The heads 32 and 40 of barrel 12 are each equipped with two series of steam injection ports 44 or 46, wherein each of the ports houses an elongated steam injector 48 or 50. The two series of ports 44 in head 32 are located so as to respectively communicate with the bores 14 and 16 of the head (see FIG. 4). Similarly, the two series of ports 46 in head 40 also respectively communicate with the bores 14 and 16 of this head.

In this embodiment, the ports 44 and 46 are oriented at oblique angles relative to the longitudinal axes of the corresponding bores 14 and 16. In practice, the ports are oriented at an angle from about 30-85 degrees, more preferably from about 30-60 degrees and most preferably about 45 degrees, relative to these axes. Moreover, the ports 44, 46 are preferably oriented in a direction toward the outlet 24. More specifically, and referring to FIG. 5, it will be seen that each representative port 44 presents a longitudinal axis 52. If this axis 52 is orthogonally resolved into components 54 and 56, the component 54 extends in a direction toward outlet 24.

The mid-barrel adjustable valve assembly head 36 is of the type described in U.S. patent application Ser. No. 11/279,379, filed Apr. 11, 2006 and incorporated by reference herein. Briefly, the head 36 includes opposed, slidable, flow restriction components 58 and 60, which can be selectively adjusted toward and away from the central shafts of the extruder screws 18 and 20, so as to vary the restriction upon material flow and thus increase pressure and shear within the extruder 10. On the other hand, the steam outlet head 38 has a steam outlet 62 with an adjustable cover 64 permitting selective escape of steam during the course of extrusion. In some instances, a vacuum device (not shown) can be used in lieu of cover 64 for more effective withdrawal of steam and/or reduction in processing pressures.

Attention is next directed to FIGS. 3 and 6-7 which depict the preferred extruder screws 18 and 20. These screws are identical in configuration, are of single flight design, and are of the co-rotating variety (i.e., the screws rotate in the same rotational direction). It will be seen that each of the screws 18, 20 broadly includes a central shaft 66 with helical fighting 68 projecting outwardly from the shaft 66. The screws 18, 20 are specially designed and have a number of novel features. These features are best described by a consideration of certain geometrical features of the screws and their relationship to each other and to the associated bores 14, 16. In particular, the shafts 66 have a root diameter R_{D} defined by the arrow 70 of FIG. 3, as well as an outermost screw diameter S_{D} defined by the screw fighting 68 and illustrated by arrow 72. In preferred practice, the ratio S_{D}/R_{D} (the flight depth ratio) of the of the outermost screw diameter to the root diameter is from about 1.9-2.5, and most preferably about 2.35.

The individual sections of each screw fighting 68 also have different pitch lengths along screws 18, 20, which are important for reasons described below. Additionally, along certain sections of the screws 18, 20, there are different free volumes within the bores 14, 16, i.e., the total bore volume in a section of the barrel 12 less the volume occupied by the screws within that section, differs along the length of the barrel 12.

In greater detail, each screw 18, 20 includes an inlet feed section 74, a first short pitch length restriction section 76 within head 30, a first longer pitch length section 78 within head 32, a second short pitch length restriction section 80 within head 34, a second longer pitch length section 82 within heads 38 and 40, and a third short pitch length restriction section 84 within head 42. It will thus be seen that the pitch lengths of screw flighting 68 of screw sections 76, 80, and 84 are substantially smaller than the corresponding pitch lengths of the flighting 68 of the screw sections 78 and 82. In preferred practice, the pitch lengths of screw sections 76, 80, and 84 range from about 0.25-1.0 screw diameters, and are most preferably about 0.33 screw diameters. The pitch length of 78 and 82 ranges from about 1-2 screw diameters, and are more preferably about 1.5 screw diameters. The ratio of the longer pitch length to the shorter pitch length preferably ranges from about 1.5-7, more preferably from about 3-6, and most preferably about 4.5. As used herein, “screw diameter” refers to the total diameter of a screw including the fighting thereof as illustrated in FIGS. 3 and 7.

The screws 18 and 20 also have very large flight depths as measured by subtracting R_{D} from S_{D}, and often expressed as the flight depth ratio S_{D}/R_{D}. This is particularly important in the long pitch sections 78 and 82, where the ratio of the pitch length to the flight depth ratio (pitch length/S_{D}/R_{D} is from about 0.4-0.9, more preferable from about 0.5-0.7, and most preferably about 0.638. In the short pitch sections 76, 80 and 84, the ratio of the pitch length to the flight depth ratio is from about 0.1-0.4, more preferably from about 0.15-0.3, and most preferably about 0.213. The intermeshed longer pitch screw sections 78 and 82 of the screws 18, 20 include a further unique feature, namely the very wide axial spacing or gap 86 between the respective screw sections. Preferably, this gap is from about 0.1-0.4 inches, more preferably from about 0.15-0.35 inches, and most preferably from about 0.236 inches. It should also be noted that the corresponding axial spacing or gap 88 between the shorter pitch screw sections 76 and 84 are much less, on the order of 0.039 inches.

These geometrical features facilitate the ends of the invention, and specifically permit low-shear extrusion of the grain(s) and/or legume(s), as compared with conventional extruder designs. It also allows incorporation of significantly greater amounts of steam into the material passing through extruder 10, as compared with such prior designs. Accordingly, the extruder 10 is capable of producing highly cooked products using significantly reduced SME inputs. The products manufactured using the extruder of the invention normally have SME inputs reduced by at least about 25%, more preferably from about 25-50%, as compared with conventionally extruded products.

In preferred forms, when the grain(s) and/or legume(s) have significant starch fractions, they are cooked to a minimum level of about 55%, more preferably from about 60-98%, and most preferably from about 60-75%. As used herein, cook levels are determined by the established procedure based upon the extent of starch gelatinization, which is fully described in the paper of Mason et al., entitled “A New Method for Determining Degree of Cook,” presented at the American Association of Cereal Chemists 67^{th} Annual Meeting, San Antonio, Tex., Oct. 26, 1982; this paper is incorporated by reference herein in its entirety.

Furthermore, the preferred products of the invention are produced using low shear extrusion methods with the input of total SME and STE, such that the ratio of total STE to SME is above about 4, more preferably from about 4-35, and most preferably from about 8-25.

The resultant cooked products of the invention also have very low cold water viscosities, i.e., up to about 600 cP, more preferably up to about 400 cP, and most preferably up to about 350 cP. In order to ascertain the cold water viscosity, an RVA (Rapid Viscoamylograph Analyzer) is employed, such as an RV4 analyzer from Newport Scientific. As used herein, “cold water viscosity” refers to an analysis carried out by placing 3.5 g (dry basis) of the extruded product into 25 g of water, so that the total dry solids concentration is 12.3%. This material is placed in the RVA analyzer with a cold temperature set at 25° C. with a paddle speed of 160 rpm. The RVA analysis proceeds at this temperature and paddle speed for a period of time until complete hydration of the sample is achieved. This time is variable depending upon the type of product being tested. For example, corn may require up to 10 minutes of time, whereas wheat may require only 3 minutes. In any case, during the analysis period, the RVA analyzer generates a curve of time versus viscosity (cP), and after the run is complete, the maximum cold water viscosity is determined from the curve.

In practice, the restriction heads 30 and 34, and 34 and 42, together with the short pitch length screw section 76, 80 and 84 therein, cooperatively create steam flow restriction zones which inhibit the passage of injected steam past these zones. As such, the zones are a form of steam locks. Additionally, provision of the heads 32, 38, and 40 with the longer pitch length screw sections 78 and 82 therein, between the restriction zones, creates steam injection zones allowing injection of greater quantities of steam than heretofore possible. The longer pitch screw sections 78 and 82 result in decreased barrel fill (not necessarily greater free volume), and thus create steam injection zones. An examination of the screws 18, 20 stopped under normal processing conditions reveals that the screw sections 76 and 80 are completely full of material, whereas the longer pitch screw sections 78 and 82 are only partially full. The orientation of the injection ports 44 and 46, and the corresponding injectors 48 and 50 therein, further enhances the incorporation of steam into the material passing through extruder 10.

The longer pitch screw sections 78 and 82 generate excellent conveyance of materials and incomplete fill of material, allowing for the unusually high level of steam injection. Moreover, the combination of the longer pitch lengths and very wide gap 86 create increased leakage flow resulting in gentle kneading of the moistened material within these sections, particularly at relatively high screw speeds of up to 900 rpm. During wet mixing or kneading of steam and water into the material being processed, low shear conditions are maintained, and the material can pass forwardly and rearwardly through the gap 86. At the same time, the gap 86 is small enough to create the desired distributive mixing of steam and water into the material.

This combination of factors within extruder 10 allows low-shear extrusion of materials with the high total STE/SME ratios and high cook values described above. Stated otherwise, processing of starchy products using extruder 10 relies to a greater extent upon STE to achieve high cook, and to a lesser extent upon SME. Conventionally, only about 3-5% steam may be injected, based upon the total dry weight of the material being processed taken as 100% by weight. As used herein, “dry weight” refers to the weight of the ingredient(s) making up the material without added water but including ingredient native water. Attempts to inject greater amounts of steam in conventional extruders normally results in the excess steam simply passing backwardly through the extruder and exiting the barrel inlet. However, in the present invention, in excess of 6% by weight steam may be successfully injected without undue injected steam loss, based upon total weight of dry material within the barrel 12 at any instance taken as 100% by weight. More particularly, testing has shown that up to about 15% by weight steam may be injected, but this limit is primarily based upon steam injection capacities and not any limitations upon the ability of the extruder to accept excess steam. Broadly therefore, the invention permits introduction of from about 7-25% by weight steam, more preferably from about 10-18% by weight, and most preferably from about 11-15% by weight.

The invention is especially adapted for the low-shear production of a wide variety of grain(s) and/or legume(s), particularly those having substantial starch fractions. For example, starch-bearing grains such as corn, wheat, sorghum, oats, rice and mixtures thereof can be processed with little or no surfactant to yield cooked, low cold water viscosity end products suitable for use in the present invention.

In the production of extruded grain(s) and/or legume(s), particularly those having substantial starch fractions, typical extrusion conditions would be: barrel retention time from about 5 to 90 seconds, more preferably from about 10 to 60 seconds; maximum barrel temperature from about 80 to 220° C., more preferably from about 100 to 140° C.; maximum pressure within the barrel, from about 100 to 1000 psi, more preferably from about 250 to 600 psi; total specific energy inputs of from about 200 to 700 kJ/kg, more preferably from about 300 to 550 kJ/kg, and STE/SME ratios as described above.

Although the extruder 10 illustrated in the Figures includes the use of an adjustable valve assembly head 36 and steam outlet head 38, the use of such heads is not required. The head 36 can advantageously be used as a further restriction against steam loss, and the head 38 can be used in instances where mid-barrel steam venting is desired, e.g., where denser products are desired. Further, although not shown, the extruder barrel may be equipped with external jackets for introduction of heat exchange media to indirectly heat or cool the material passing through the extruders.

### Preferred Preconditioner

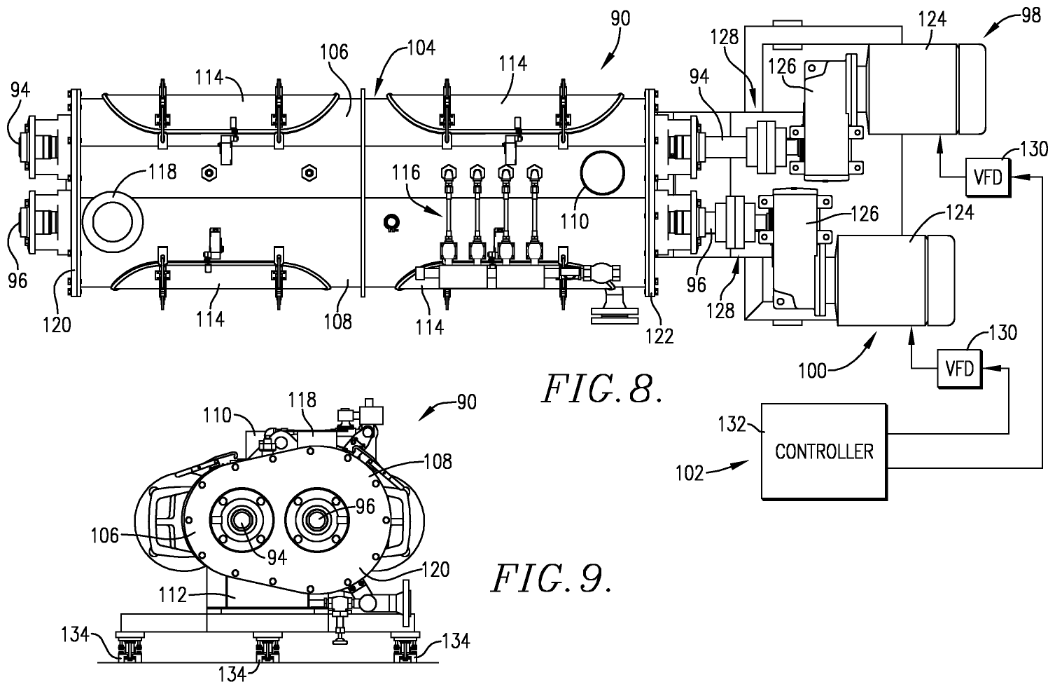

Turning next to FIGS. 8-9, a preferred preconditioner 90 is depicted. This preconditioner is fully illustrated and described in US Patent Publication No. 2008/0094939, incorporated by reference herein. Broadly, the preconditioner 90 includes an elongated mixing vessel 92 with a pair of parallel, elongated, axially extending mixing shafts 94 and 96 within and extending along the length thereof. The shafts 94, 96 are operably coupled with individual variable drive devices 98 and 100, the latter in turn connected with digital control device 102. The preconditioner 90 is positioned upstream of extruder 10, such that the output from the preconditioner is directed into the outlet 22 of extruder barrel 12.

In more detail, the vessel 92 has an elongated, transversely arcuate sidewall 104 presenting a pair of elongated, juxtaposed, intercommunicated chambers 106 and 108, as well as a material inlet 110 and a material outlet 112. The chamber 108 has a larger cross-sectional area than the adjacent chamber 106. The sidewall 104 has access doors 114 and is also equipped with injection assemblies 116 for injection of water and/or steam into the confines of vessel 92 during use of the preconditioner, and a vapor outlet 118. The opposed ends of vessel 92 have end plates 120 and 122, as shown.

Each of the shafts 94, 96 extends the full length of the corresponding chambers 106, 108 along the center line thereof, and has a plurality of radially outwardly extending paddle-type mixing elements (not shown) which are designed to agitate and mix material fed to the preconditioner, and to convey the material from inlet 110 towards and out outlet 112. The mixing elements on each shaft 94, 96 are axially offset relative to the elements on the adjacent shaft. Moreover, the mixing elements are intercalated (i.e., the elements on shaft 94 extend into the cylindrical operational envelope presented by shaft 94 and the elements thereon, and vice versa). The mixing elements may be oriented substantially perpendicularly to the shafts 94, 96. In other embodiments, the mixing elements may be adjusted in both length and pitch, at the discretion of the user.

The drives 98 and 100 are in the illustrated embodiment identical in terms of hardware, and each includes a drive motor 124, a gear reducer 126, and coupling assembly 128 serving to interconnect the corresponding gear reducer 126 and motor 124 with a shaft 94 or 96. The drives 98 and 100 also preferably have variable frequency drives 130 which are designed to permit selective, individual rotation of the shafts 94, 96 in terms of speed and/or rotational direction independently of each other. In order to provide appropriate control for the drives 98 and 100, the drives 130 are each coupled between a corresponding motor 124 and a control device 132. The control device 132 may be a controller, processor, application specific integrated circuit (ASIC), or any other type of digital or analog device capable of executing logical instructions. The device may even be a personal or server computer such as those manufactured and sold by Dell, Compaq, Gateway, or any other computer manufacturer, network computers running Windows NT, Novel Netware, Unix, or any other network operating system. The drives 130 may be programmed as desired to achieve the ends of the invention, e.g., they may be configured for different rotational speed ranges, rotational directions (i.e., either in a forward (F) direction serving to move the product toward the outlet of vessel 92, or in a reverse (R) direction moving the product backwardly to give more residence time in the vessel) and power ratings.

In preferred forms, the preconditioner 90 is supported on a weighing device in the form of a plurality of load cells 134, which are also operatively coupled with control device 132. The use of load cells 134 permits rapid, on-the-go variation in the retention time of material passing through vessel 92, as described in detail in U.S. Pat. No. 6,465,029, incorporated by reference herein.

The use of the preferred variable frequency drive mechanisms 98, 100 and control device 132 allow high-speed adjustments of the rotational speeds of the shafts 94, 96 to achieve desired preconditioning while avoiding any collisions between the intermeshed mixing elements supported on the shafts 94, 96. In general, the control device 132 and the coupled drives 130 communicate with each drive motor 124 to control the shaft speeds. Additionally, the shafts 94, 96 can be rotated in different or the same rotational directions at the discretion of the operator. Generally, the shaft 94 is rotated at a speed greater than that of the shaft 96.

Retention times for material passing through preconditioner 90 can be controlled manually by adjusting shaft speed and/or direction, or, more preferably, automatically through control device 132. Weight information from the load cells 134 is directed to control device 132, which in turn makes shaft speed and/or directional changes based upon a desired retention time.

Preconditioning of starch-bearing grain(s) and/or legume(s) serves to at least partially gelatinize and cook the materials during passage through the preconditioner; advantageously, the cook value off of the preconditioner should be at least about 15%, more preferably from about 15-45%, and most preferably from about 25-40%. The preconditioner 10 is usually operated at temperatures of from about 100-212° F., residence times of from about 30 seconds-5 minutes, and at atmospheric or slightly above pressures.

The drive arrangement for the preconditioner 90 has the capability of rotating the shafts 94, 96 at infinitely variable speeds of up to about 1,000 rpm, more preferably from about 200-900 rpm. Moreover, the operational flexibility of operation inherent in the preconditioner design allows for greater levels of cook (i.e., starch gelatinization) as compared with similarly sized conventional preconditioners.

As noted, in the methods of the invention, inputs of STE and SME may achieve a ratio of total STE (from preconditioning and extrusion) to total SME (from preconditioning and extrusion) of at least about 4, and preferably greater. As also mentioned, SME input from the preconditioner is very small in comparison with that of the extruder, and preconditioner SME may normally be ignored.

### Production of Tortilla Products

After extrusion of the desired grain(s) and/or legume(s) desired for tortilla products, the grain(s) and/or legume(s) are ground to an average particle size of from about 100-850 microns, more preferably from about 250-500 microns. These ground materials are then mixed with water and other ingredients in accordance with a tortilla product precursor recipe to form a dough. These other ingredients may be selected from a wide variety of different ingredients including shortening, salt, fats, pH control and mold inhibitors, dough conditioners (e.g., reducing agents, emulsifiers, gums), preservatives, flavorings, citric acid, seasonings, leavening agents, carboxymethylcellulose, glycerol, oils, and mixtures thereof. In certain embodiments, particularly where non-wheat grains are employed, the tortilla recipes would be essentially free (e.g., less than about 2% by weight) of gums and pregelled starches.

Generally speaking, the previously extruded grains(s) and/or legume(s) fraction of the precursor recipes should represent at least about 65% by weight, and more preferably at least about 85% by weight, of the precursor recipes. Although corn-only tortilla products can be produced in accordance with the invention, in most instances the precursor recipes contain no more than about 80% by weight extruded corn, and more preferably no more than about 50% by weight extruded corn, all based upon the total weight of the recipe taken as 100% by weight. In certain embodiments, the precursor recipes are essentially free of extruded corn (e.g., no more than about 5% by weight).

The grains usable in the invention cover virtually any grain, for example amaranth, barley, bran, buckwheat, bulgur, corn, couscous, durum, einkorn, emmer, farina, faro, flax, freekeh, kamut, lentil, millet, miso, oats, orzo, peas, quinoa, white rice, brown rice, rye, sorghum, spelt, teff, semolina, triticale, wheat, and mixtures thereof. Likewise, any suitable legume may be used, such as asparagus bean or snake bean, asparagus pea, baby lima bean, black bean, black turtle bean, Boston bean, Boston navy bean, broad bean, cannellini bean, chickpeas, chili bean, coco bean, cranberry bean, Egyptian bean, Egyptian white broad bean, English bean, fava bean, fava-coceira, field pea, French green beans, frijo bola roja, frijole negro, great Northern bean, green beans, green and yellow peas, kidney beans, lima bean, Madagascar bean, Mexican black bean, Mexican red bean, molasses face bean, mung bean, mung pea, mungo bean, navy bean, pea bean, Peruvian bean, pinto bean, red bean, red eye bean, red kidney bean, rice bean, runner bean, scarlet runner bean, small red bean, small white bean, soy bean or soybean, wax bean, white kidney bean, white pea bean, and mixtures thereof. Normally, the grains and/or legumes used in the invention contain sufficient native starch, so that no added starch is needed to produce quality tortillas. However, added starch (which may be pregelled) may be a part of certain tortilla recipes if needed.

Another feature of the present invention is the ability to produce quality tortilla products which are entirely gluten free. In such instances, the previously extruded grain(s) are typically selected from amaranth, buckwheat, millet, quinoa, rice, sorghum, teff, and mixtures thereof. In the preparation of such gluten-free products, the recipes may be essentially free of gums and pregelled starches.

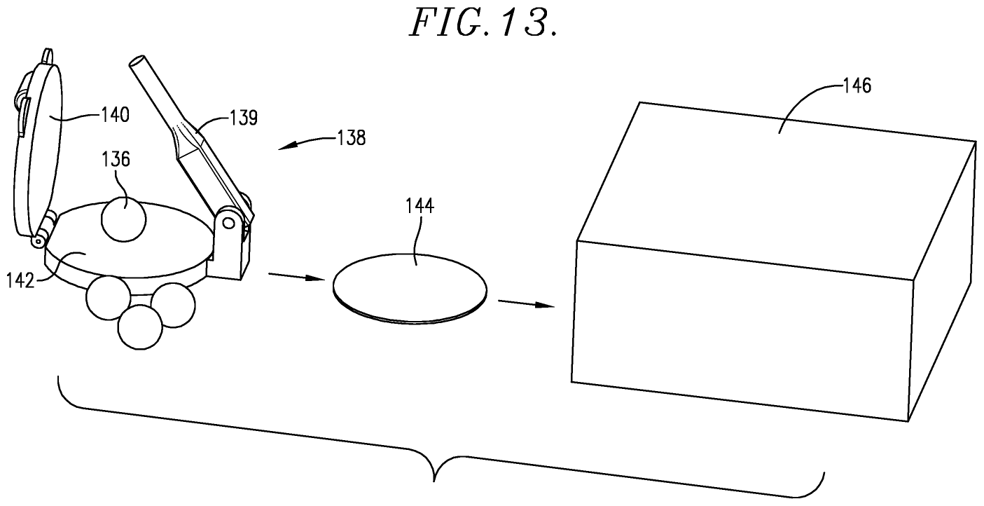

In the next step, portions of the product precursor dough are divided into individual portions, such as rounded balls 136 (FIG. 13). In commercial operations, a divider-rounder device may be used for this purpose. The balls 136 are then flattened using any convenient device. Commercially, continuous heated press machinery is employed. In low-capacity situations, a manual press 138 having an operating lever 139 and a pair of opposed press plates 140, 142 may be used. In either case, flattened tortilla precursors 144 are produced. These precursors 144 are then finished using cooking apparatus generally referred to by the numeral 146. In most instances, the apparatus 146 is in the form of a multiple-pass oven. Baking conditions are variable, but generally the precursors 144 are subjected to baking at a temperature of from about 350-475° F., more preferably from about 400-450° F., for a period of from about 0.5-3 minutes, more preferably from about 0.75-2 minutes. This gives final tortilla products.

The apparatus 146 may also include a downstream fryer wherein the baked tortilla products are fried to give chip products.

### EXAMPLES

The following examples set forth the preferred apparatus and methods in accordance with the invention. It is to be understood, however, that these examples are provided by way of illustration and nothing therein should be taken as a limitation upon the overall scope of the invention.

### Example 1

In this example, three different types of corn, namely yellow, white, and blue, were processed through a Wenger HIP preconditioner, followed by extrusion through a Wenger Thermal Twin extruder as described above and depicted in FIGS. 1-9. The extrudate for each test was then dried using a conventional three-pass dryer, followed by coarse grinding. The following table sets forth pertinent conditions during these test runs.

| | | | |
|---|---|---|---|
| Raw Material | yellow corn | white corn | blue corn |

Preconditioner

| | | | |
|---|---|---|---|
| Large Side (rpm) | 250 | 250 | 250 |
| Small Side (rpm) | 300 | 300 | 300 |
| Steam Flow (kg/hr) | 129 | 70 | 70 |
| Water Flow (kg/hr | 330 | 318 | 309 |
| Discharge Temp (° C.) | 67 | 67 | 70 |

Extruder

| | | | |
|---|---|---|---|
| Shaft Speeds (rpm) | 551 | 527 | 526 |
| Motor Load (%) | 36 | 39 | 38 |
| Motor Power (KW) | 13 | 15 | 14 |
| Discharge Temp (° C.) | 81 | 80 | 80 |

Dried Product

| | | | |
|---|---|---|---|
| Moisture (% wb) | 7.6 | 7.0 | 8.3 |
| Total Starch (%) | 83.6 | 84.4 | 72.2 |
| Gelatinized Starch (%) | 34.4 | 43.3 | 40.6 |
| Cook Value (%) | 41.1 | 51.3 | 56.3 |

Ground Product

| | | | |
|---|---|---|---|
| Mean Diameter (μ) | — | — | 366.08 |
| Surface Area (cm²/g) | — | — | 132.74 |
| Particles/g | — | — | 45,084 |
| 68% between low/high (μ) | — | — | 222/604 |
| 95% between low/high (μ) | — | — | 111/1209 |

These ground products were then tested using a RVA device in order to determine the cold water solubility of the products. These results are set forth in FIG. 13.

The above extruded white corn product was used to prepare hot-pressed tortillas similar to standard wheat flour tortillas. In general, the process involved mixing the extruded white corn product with various other ingredients (as set forth below) and water in a multiple-speed Hobart mixer with a paddle blade until a moist dough was achieved. At this point, small balls of dough of approximately 40 g were manually prepared and subjected to a conventional hot-press process using a commercial, dual platen tortilla press. The pressed products were then conventionally baked in an oven (from about 375-410° F. for a period of from about 1.5-2 minutes) to obtain a final product. These products were then texture tested using a Perten texture analyzer with a flat blade probe. The following sets forth the ingredients used in each test, and the texture test results.

Ingredients/Mixing Regime/Dough Temperature

### Test 1:

Ingredients
10 lbs extruded white corn
0.03 lbs calcium propionate
0.15 lbs salt
10 lbs ambient water

Hobart Mixing Regime/Dough Temperature
One minute at speed 1; 30 seconds at speed 3; 77° F.

### Test 2:

Ingredients
10 lbs extruded white corn
0.03 lbs calcium propionate
0.15 lbs salt
10 lbs ambient water

Hobart Mixing Regime/Dough Temperature
One minute at speed 1; 30 seconds at speed 2; 77° F.

### Test 3:

Ingredients
10 lbs extruded white corn
0.03 lbs calcium propionate
0.15 lbs salt
10 lbs ambient water

Hobart Mixing Regime
Two minutes at speed 3

### Test 4:

Ingredients
10 lbs extruded white corn
0.03 lbs calcium propionate
0.15 lbs salt
0.025 lbs Cerol 30,000 (GMS—glycerol monostearate)
9 lbs ambient water

Hobart Mixing Regime
Two minutes at speed 3;

### Test 5:

Ingredients
10 lbs extruded white corn
0.03 lbs calcium propionate
0.15 lbs salt
0.025 lbs Cerol 30,000 (GMS)
0.025 lbs Dalsguard DMG (distilled monoglycerides of vegetable fatty acids)
8.5 lbs ambient water

Hobart Mixing Regime
One minute at speed 1; two minutes at speed 3

### Test 6:

Ingredients
10 lbs extruded white corn
0.03 lbs calcium propionate
0.15 lbs salt
0.025 lbs glycerol 30,000
0.025 lbs Dalsguard DMG
8.5 lbs ambient water
   Hobart Mixing Regime
One minute at speed 1; 30 seconds at speed 2

### Test 7:

Ingredients
10 lbs extruded white corn
0.03 lbs calcium propionate
0.15 lbs salt
0.025 lbs CMC (carboxymethylcellulose)
0.025 lbs Dalsguard DMG
8.5 lbs ambient water

Hobart Mixing Regime
One minute at speed 1; 30 seconds at speed 2

### Test 8:

Ingredients
10 lbs extruded white corn
0.03 lbs calcium propionate
0.15 lbs salt
0.025 lbs CMC (carboxymethylcellulose)
0.025 lbs Dalsguard DMG
8.5 lbs ambient water

Hobart Mixing Regime
Two minutes at speed 3

### Test 9:

Ingredients
10 lbs extruded white corn
0.03 lbs calcium propionate
0.15 lbs salt
0.025 lbs CMC (carboxymethylcellulose)
0.025 lbs Dalsguard DMG
0.2 lbs Canola oil
8.5 lbs ambient water

Hobart Mixing Regime
One minute at speed 1; two minutes at speed 3

| | | | | | | Break | |
|---|---|---|---|---|---|---|---|
| Test | Moisture | Thickness | Diameter 1¹ | Diameter 2 | Weight | Point | Stretchability/ |
| No. | (%) | (mm) | (mm) | (mm) | (g) | (g) | Flexibility |
| 1 | — | — | — | — | — | — | — |
| 2 | 38.7 | 2.4 | 143.6 | 135.7 | 31.3 | 1466 | 3 |
| 3 | 37.1 | 2.4 | 149.5 | 138.0 | 33 | 1824 | 3 |
| 4 | — | — | — | — | — | — | — |
| 5 | 37.1 | 2.8 | 120.7 | 120.7 | 31.8 | 2487 | 3 |
| 6 | 37.4 | 2.9 | 133.7 | 128.9 | 36.4 | 2913 | 3 |
| 7 | 39.5 | 2.5 | 143.4 | 130.7 | 37.0 | 2539 | 3 |
| 8 | 36.3 | 1.9 | 151.6 | 144.3 | 33.8 | 1972 | 3 |
| 9 | 36.3 | 2.2 | 156.3 | 150.2 | 40.0 | 2084 | 3 |

¹Diameters 1 and 2 were measured at two orthogonal positions across tortillas

### Test Run Comments

Test 1—425° F. platen temperature; maximum press load; some splitting/holes in tortilla matrix.
Test 2—450° F. platen temperature; some splitting in tortilla matrix.
Test 3—some holes in tortilla matrix.
Test 4—product too sticky.
Test 5—some tortillas blew out; other tortillas very good.
Test 6—less sticky tortilla with ragged edges.
Test 7—decreased plate pressure to prevent blowout of tortillas; probably too much oil.
Test 8—dusted dough balls with corn flour before pressing; 350° F. platen temperature; no splitting or holes; very good product.
Test 9—lower oil content; very good product; some bubbles/blisters on tortilla surfaces.

### Example 2

In this Example, nine products in accordance with the invention were produced. In each instance, the recipes consisted of extruded grains, namely long-grain rice (Runs 1-3), brown rice flour (Runs 4-6), and quinoa (Runs 7-9). In each case, the grains were subjected to processing using a HIP preconditioner (with added water and/or stream) and a Thermal Twin extruder described above and depicted in FIGS. 1-9.

The following Table sets forth the grain extrusion conditions for these Runs, along with the moisture contents of the extruded doughs, total starch, total gelatinized starch, and cook values thereof.

| Parameter | Run 1 | Run 2 | Run 3 | Run 4 | Run 5 | Run 6 | Run 7 | Run 8 | Run 9 |
|---|---|---|---|---|---|---|---|---|---|
| dry recipe density--kg/m³ | 678 | — | — | — | — | — | — | — | — |
| dry recipe rate--kg/hr | 1000 | 1000 | 1000- | 1000 | 1000 | 1000 | 1000 | 1000 | 1000 |
| feed screw speed--rpm | 46.4 | 48 | 51.7 | 52.9 | 56 | 51.8 | 55.6 | 66.4 | 72/2 |
| HIP small side speed--rpm | 120 | 120 | 120 | 650 | 650 | 650 | 650 | 650 | 650 |
| HIP large side speed--rpm | 650 | 650 | 650 | 120 | 120 | 120 | 120 | 120 | 120 |
| steam flow to HIP--kg/hr | — | 32 | 36 | — | 39 | 46 | — | 36 | — |
| water flow to HIP--kg/hr | 210 | 180 | 170 | 210 | 190 | 176 | 230 | 220 | 270 |
| HIP product discharge temp--° C. | 37 | 58 | 64 | 42 | 70 | 71 | 46 | 66 | 47 |
| extruder shaft speed--rpm | 470 | 470 | 470 | 470 | 471 | 471 | 471 | 471 | 471 |
| extruder motor load--% | 64 | 55 | — | 57 | 58 | 58 | 48 | 54 | 59 |
| water flow to extruder--kg/hr | 120 | 120 | 120 | 120 | 120 | 120 | 170 | 190 | 190 |
| control/temp first head--° C. | 60/58 | 60/63 | 60/67 | 60/58 | 60/66 | 60/71 | 60/63 | 60/66 | 60/61 |
| control/temp second head--° C. | — | — | — | 100/68 | 100/75 | 100/80 | 100/74 | 100/71 | 100/73 |
| control/temp third head--° C. | 100/63 | 100/62 | 100/69 | 90/22 | 90/22 | 90/22 | 90/22 | 90/22 | 90/22 |
| control/temp fourth head--° C. | — | 90/22 | 90/22 | — | — | — | — | — | — |
| temp die spacer--° C. | 75.8 | 86 | 95.9 | 77.7 | 95.6 | 98.5 | 77.0 | 87.2 | 78.8 |
| extruder discharge density--kg/m² | 510 | 516 | 414 | 534 | 570 | 520 | 498 | 470 | 552 |
| extrudate moisture--% wb | 8.61 | 10.09 | 8.21 | 6.91 | 8.87 | 9.04 | 5.00 | 8.68 | 7.90 |
| total starch--% wb | 92.57 | 94.09 | 90.99 | 82.57 | 81.77 | 82.92 | 79.39 | 78.65 | 81.69 |
| gelatinized starch--% wb | 39.98 | 68.27 | 74.52 | 38.29 | 60.44 | 62.14 | 61.20 | 74.51 | 67.04 |
| cook--% | 43.2 | 72.6 | 81.9 | 46.4 | 73.9 | 74.9 | 77.1 | 94.7 | 82.1 |

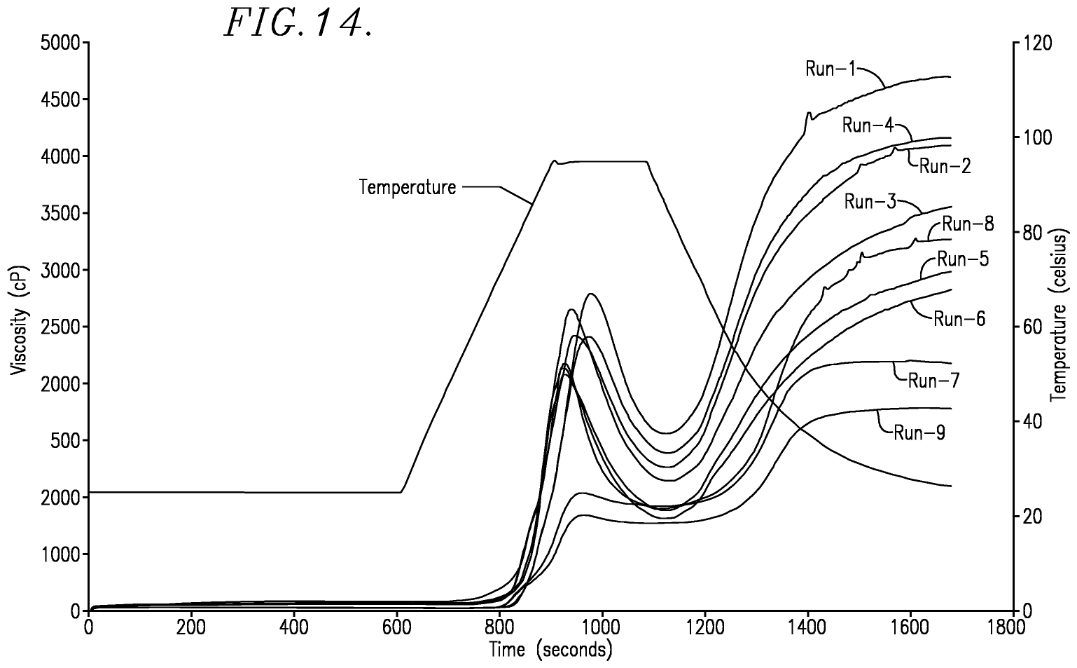

After extrusion, the grains were dried and ground, and subjected to RVA (FIG. 14). Thereupon, the ground grains were used to make tortilla precursor dough mixtures according to the recipes given below. The dough mixtures were then formed into balls of approximately 40-45 grams and pressed into flat, substantially round tortilla precursors using a commercial heated tortilla press. After pressing, the precursors were griddled in lieu of baking to create tortillas. Then, a sample of the tortillas were cut and fried to create tortilla chips.

Tortilla Precursor Mixtures

| Test | Ingredients | Grams |
|---|---|---|
| 1 | Extruded Long Grain Rice | 250 |
| | Shortening | 10 |
| | Salt | 3.75 |
| | Water | 200 |
| 2 | Extruded Brown Rice Flour | 250 |
| | Shortening | 10 |
| | Salt | 3.75 |
| | Water | 205 |
| 3 | Extruded Quinoa | 125 |
| | Long Grain Rice | 125 |
| | Shortening | 10 |
| | Salt | 3.75 |
| | Water | 185 |
| 4 | Extruded Long Grain Rice | 187.5 |
| | ADM Cooked Black Bean Flour | 62.5 |
| | Shortening | 10 |
| | Salt | 3.75 |
| | Water | 212 |
| 5 | Extruded Long Grain Rice | 225 |
| | ADM Cooked Black Bean Flour | 25 |
| | Shortening | 10 |
| | Salt | 3.75 |
| | Water | 205 |
| 6 | Extruded Blue Corn | 250 |
| | Salt | 3.75 |
| | Water | 195 |
| 7 | Extruded White Corn | 250 |
| | Salt | 3.75 |
| | Water | 210 |
| 8 | Extruded Brown Rice Flour | 250 |
| | Shortening | 10 |
| | Salt | 3.75 |
| | Water | 200 |
| | Spinach Powder | 7.5 |
| | Garlic Powder | 2.5 |
| 9 | Extruded Brown Rice Flour | 250 |
| | Shortening | 10 |
| | Salt | 3.75 |
| | Water | 200 |
| | Italian Seasoning | 0.5 |
| | Garlic Powder | 2.5 |
| | Dried Tomato | 25 |

The dough balls were then subjected to the following conditions in the commercial press and griddle.

| Parameter | Test 1 | Test 2 | Test 3 | Test 4 | Test 5 | Test 6 | Test 7 | Test 8 | Test 9 |
|---|---|---|---|---|---|---|---|---|---|
| plate pressure--psi | 200 | 200 | 200 | 200 | 200 | 200 | 200 | 200 | 200 |
| press time--seconds | 15 | 15 | 15 | 15 | 15 | 7 | 7 | 7 | 7 |
| plate temp--° F. | 200 | 200 | 200 | 200 | 200 | 240 | 240 | 200 | 200 |
| griddle temp--° F. | 325 | 325 | 325 | 325 | 325 | 325 | 325 | 325 | 325 |
| griddle time--seconds¹ | 20/30/20 | 20/30/20 | 20/30/20 | 20/30/20 | 20/30/20 | 20/30/20 | 20/30/20 | 20/30/20 | 20/30/20 |
| product moisture--% wb | 27.41 | 30.62 | — | — | — | — | — | — | — |

¹The tortilla precursors were heated on the griddle on a first side/second side/first side regimen for the times indicated to create the final tortillas.

The final tortilla products were tested using a product texture analyzer and certain of the products were cut into pieces and fried, thereby yielding chip products. Both the final tortilla and chip products were commercially acceptable.

| | Piece Wt | | | |
|---|---|---|---|---|
| | after baking | Thickness | Diameter | Texture |
| Test | (g) | (mm) | (in) | (g) |
| 1 | 33.34 | 1 | 7.25 | 4783 |
| 2 | 32.97 | 0.9-1 | 7.75 | 3262 |
| 3 | 35.69 | 1.05-1.1 | 7.25 | 4205 |
| 4 | 34.13 | 1.15-1.2 | 7 | 3161 |
| 5 | 34.27 | 1.1-1.15 | 7 | 3146 |
| 6 | 36.49 | 1.25-1.35 | 7 | 3208 |
| 7 | 37.42 | 1.4-1.5 | 6.5-6.75 | 2937 |
| 8 | 35.17 | 0.98-1.1 | 7.25-7.5 | 2369 |
| 9 | 32.82 | 1.05-1.1 | 7.75 | 3020 |

Initial starting dough weight was 45 grams.

I claim:

1. A method of making a tortilla product, comprising the steps of:
forming a flat tortilla product precursor using a tortilla product recipe comprising one or more previously extruded and ground grain(s) and/or legume(s) and water,
said forming step comprising the step of pressing a quantity of said precursor between a pair of forming plates;
said previously extruded and ground grain(s) and/or legume(s) produced by passing grain(s) and/or legume(s) into and through a twin-screw extruder to yield extrudate(s) having a cold water viscosity of up to about 600 cP, and thereafter grinding said extrudate(s); and
cooking said flat tortilla product precursor to provide said tortilla product.

2. The method of claim 1, said grain(s) selected from the group consisting of amaranth, barley, bran, buckwheat, bulgur, corn, couscous, durum, eikorn, emmer, farina, faro, flax, freekeh, kamut, lentil, millet, miso, oats, orzo, peas, quinoa, white rice, brown rice, rye, sorghum, spelt, teff, semolina, triticale, wheat, and mixtures thereof.

3. The method of claim 1, said legume(s) selected from the group consisting of asparagus bean or snake bean, asparagus pea, baby lima bean, black bean, black turtle bean, Boston bean, Boston navy bean, broad bean, cannellini bean, chickpeas, chili bean, coco bean, cranberry bean, Egyptian bean, Egyptian white broad bean, English bean, fava bean, fava-coceira, field pea, French green beans, frijo bola roja, frijole negro, great Northern bean, green beans, green and yellow peas, kidney beans, lima bean, Madagascar bean, Mexican black bean, Mexican red bean, molasses face bean, mung bean, mung pea, mungo bean, navy bean, pea bean, Peruvian bean, pinto bean, red bean, red eye bean, red kidney bean, rice bean, runner bean, scarlet runner bean, small red bean, small white bean, soy bean or soybean, wax bean, white kidney bean, white pea bean, and mixtures thereof.

4. The method of claim 1, including the step of pressing said quantity of tortilla product recipe between said plates at a pressure of from about 150-350 psi.

5. The method of claim 1, said cooking step comprising the step of baking said flat tortilla product precursor to provide said tortilla product.

6. The method of claim 5, said cooking step further comprising the step of frying the baked tortilla product.

7. The method of claim 5, said baking step carried out at a temperature of from about 350-475° F. for a time of from about 0.5-3 minutes.

8. The method of claim 1, said tortilla product recipe further including one or more ingredients selected from the group consisting of shortening, salt, fats, pH control and mold inhibitors, dough conditioners, preservatives, flavorings, citric acid, seasonings, leavening agents, carboxymethylcellulose, glycerol, oils, and mixtures thereof.

9. The method of claim 1, said passing step including the step of retaining said grain(s) and/or legume(s) within said extruder for a time of from about 5-90 seconds.

10. The method of claim 1, said passing step including the step of subjecting said grain(s) and/or legume(s) to a maximum temperature within the extruder of from about 80-220° C.

11. The method of claim 1, said passing step including the step of subjecting said grain(s) and/or legume(s) to a pressure within the extruder of from about 100-1000 psi.

12. The method of claim 1, said passing step including the step of subjecting said grain(s) and/or legume(s) to a total specific energy input within the extruder of from about 200-700 kJ/kg.

13. The method of claim 1, said tortilla product recipe including one or more starch-bearing ingredients, the starch fraction of said ingredients after said passing step having a cook value of from about 55-98%.

14. The method of claim 13, said cook value being from about 60-98%.

15. The method of claim 1, said tortilla product recipe being essentially gluten free.

16. The method of claim 1, the extrusion of said one or more grain(s) and/or legume(s) comprising the steps of first preconditioning said grain(s) and/or legume(s), and then passing the preconditioned grain(s) and/or legume(s) into and through a twin-screw extruder.

17. The method of claim 1, said tortilla product recipe containing no more than about 80% by weight extruded corn, based upon the total weight of the recipe taken as 100% by weight.

18. The method of claim 17, said tortilla product recipe being essentially free of extruded corn.

19. A method of making a tortilla product, comprising the steps of:
extruding one or more grain(s) and/or legume(s) through a twin-screw extruder to yield an extrudate having a cold water viscosity of up to about 600 cP;
grinding said extrudate;
mixing said ground extrudate with additional ingredients and water to give a tortilla product recipe dough;
forming a flat tortilla product precursor by flattening a portion of said dough between pressure plates; and
baking said flat tortilla product precursor.
